(19) United States
(12) Patent Application Publication
(10) Pub. No.: US 2008/0291144 A1
(43) Pub. Date: Nov. 27, 2008

(54) Liquid crystal display having common voltage modulator

(75) Inventor: Hung-Yu Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/154,829

(22) Filed: May 27, 2008

(30) Foreign Application Priority Data
May 25, 2007 (CN) 200710074608.9

(51) Int. Cl. G09G 3/36

(52) U.S. Cl. 345/89; 345/87

(57) ABSTRACT

An exemplary liquid crystal display includes a common electrode capable of having a predetermined common voltage applied thereto, a first common voltage line connected to the common electrode, a second common voltage line connected to the common electrode, and a common voltage modulator connected to the first and second common voltage lines. The first and second common voltage lines have no overlap and being at opposite sides of the liquid crystal display. The common voltage modulator is configured to receive a distorted common voltage from the common electrode via the first common voltage line, and apply a corresponding compensating voltage to the common electrode via the second common voltage line.

### FIELD OF THE INVENTION

The present invention relates to liquid crystal displays (LCDs) and the stabilizing of common voltages thereof, and more particularly to an LCD utilizing a common voltage modulator to keep the common voltage of the LCD stable.

### BACKGROUND

Because many LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace cathode ray tube (CRT) monitors and televisions.

Referring to FIG. 4, a typical LCD 10 includes a liquid crystal panel 11, a timing controller 12, a gate driving circuit 13, a data driving circuit 14, and a common voltage source 15. The gate driving circuit 13 is used for providing a plurality of scanning signals to the liquid crystal panel 11. The data driving circuit 14 is used for providing a plurality of gray scale voltages to the liquid crystal panel I1. The timing controller 12 is used for controlling the gate driving circuit 13 and the data driving circuit 14. The common voltage source 15 is used for providing a predetermined common voltage to the liquid crystal panel 11.

The liquid crystal panel 11 includes a plurality of scanning lines 131 parallel to each other, a plurality of data lines 141 parallel to each other and orthogonal to the scanning lines 131, a common voltage line 101, a plurality of thin film transistors (TFTs) 16 arranged in the vicinity of points of intersection of the scanning lines 131 and the data lines 141, a plurality of pixel electrodes 17 corresponding to the TFTs 16, and a plurality of common electrodes 18 generally opposite to the pixel electrodes 17 respectively.

Each TFT 16 includes a gate electrode (not labeled) connected to the corresponding scanning line 131, a source electrode (not labeled) connected to the corresponding data line 141, and a drain electrode (not labeled) connected to the pixel electrode 17. The common electrodes 18 of the TFTs 16 are substantially connected together and to the common voltage source 15 via the common voltage line 101. The common voltage line 101 is insulated from the scanning lines 131 and the data lines 141, and is arranged at an edge of the liquid crystal panel 11 near the gate driving circuit 13. A plurality of branch lines (not labeled) extend from the common voltage line 101, each branch line connecting to a respective row of the common electrodes 18. Thereby, all the common electrodes 18 have the common voltage applied thereto. The common voltage is a constant direct current voltage, and may for example be 5 volts (V).

The timing controller 12 generates a plurality of scanning synchronization signals (S-SYNC), and provides the S-SYNC to the gate driving circuit 13. The gate driving circuit 13 thereby applies plural scanning signals to the scanning lines 131 sequentially. When one scanning line 131 is being scanned, the corresponding TFTs 16 that are connected to the scanning line 131 are switched on.

The timing controller 12 further generates a plurality of data synchronization signals (D-SYNC), and provides the D-SYNC to the data driving circuit 14. The data driving circuit 14 thereby applies plural gray scale voltages to the data lines 141 simultaneously each time one of the scanning lines 131 is being scanned. The gray scale voltages are applied to corresponding pixel electrodes 17 via corresponding on-state TFTs 16.

When a gray scale voltage is applied to each pixel electrode 17, an electric field is generated between the pixel electrode 17 and the corresponding common electrode 18. Generally, the scanning lines 131 and the data lines 141 are insulated from each other by an insulating layer provided therebetween. Therefore, parasitic capacitors are inevitably formed between the scanning lines 131 and the data lines 141. Each parasitic capacitor is capable of interfering with operation of the liquid crystal panel 11. In particular, when the gray scale voltages applied to the pixel electrode 17 are pulled up or pulled down rapidly, the voltage of the common electrode 18 corresponding to the pixel electrode 17 is correspondingly pulled up or pulled down due to a coupling effect of the parasitic capacitor. When this happens, the voltages of other common electrodes 18 are distorted correspondingly, and so-called ripples in voltages of other common electrodes 18 occurs. These disturbances are liable to impair the quality of images displayed by the LCD 10. Further, these disturbances are liable to induce crosstalk, which can degrade operation of the liquid crystal panel 11 and further impair the quality of images displayed by the LCD 10.

What is needed, therefore, is an LCD that can overcome the above-described deficiencies.

### SUMMARY

In an exemplary embodiment, a liquid crystal display includes a common electrode capable of having a predetermined common voltage applied thereto, a first common voltage line connected to the common electrode, a second common voltage line connected to the common electrode, and a common voltage modulator connected to the first and second common voltage lines. The first and second common voltage lines have no overlap and being at opposite sides of the liquid crystal display. The common voltage modulator is configured to receive a distorted common voltage from the common electrode via the first common voltage line, and apply a corresponding compensating voltage to the common electrode via the second common voltage line.

Other aspects, novel features and advantages will become more apparent from the following detailed description when taken in conjunction with the accompanying drawings.

### BRIEF DESCRIPTION OF THE DRAWINGS

FIG. 1 is essentially an abbreviated circuit diagram of an LCD according to an exemplary embodiment of the present invention, the LCD device including a common voltage modulator.

FIG. 2 is a circuit diagram of the common voltage modulator of FIG. 1.

FIG. 3 is a schematic timing chart of waveforms illustrating a working principle of the common voltage modulator.

FIG. 4 is essentially an abbreviated circuit diagram of a conventional LCD.

The components in the drawings are not necessarily drawn to scale, the emphasis instead being placed upon clearly illustrating the principles of the described embodiments. In the drawings, like reference numerals designate corresponding parts throughout various views, and all the views are schematic.

### DETAILED DESCRIPTION OF EMBODIMENTS

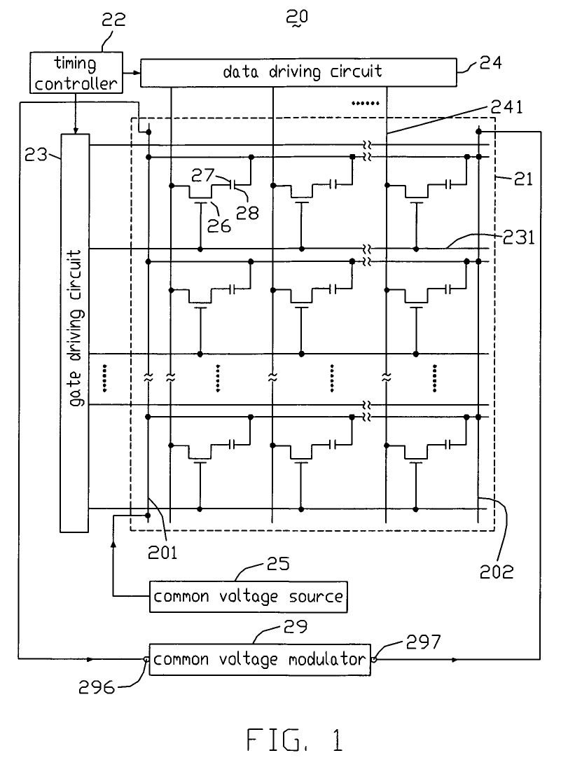

Referring to FIG. 1, an LCD 20 according to an exemplary embodiment of the present invention is shown. The LCD 20 includes a liquid crystal panel 21, a timing controller 22, a gate driving circuit 23, a data driving circuit 24, a common voltage source 25, and a common voltage modulator 29. The gate driving circuit 23 is used for providing a plurality of scanning signals to the liquid crystal panel 21. The data driving circuit 24 is used for providing a plurality of gray scale voltages to the liquid crystal panel 21. The timing controller 22 is used for controlling the gate driving circuit 23 and the data driving circuit 24. The common voltage source 25 is used for providing a predetermined common voltage to the liquid crystal panel 21. The common voltage modulator 29 is used for providing a plurality of compensating voltages to keep the common voltage stable.

The liquid crystal panel 21 includes a plurality of scanning lines 231 parallel to each other, a plurality of data lines 241 parallel to each other and orthogonal to the scanning lines 231, a plurality of TFTs 26 arranged in the vicinity of points of intersection of the scanning lines 231 and the data lines 241, a plurality of pixel electrodes 27 corresponding to the TFTs 26, a plurality of common electrodes 28 generally opposite to the pixel electrodes 27 respectively, a first common voltage line 201, and a second voltage line 202. The common voltage modulator 29 includes an input terminal 296 and an output terminal 297.

Each TFT 26 includes a gate electrode (not labeled) connected to the corresponding scanning line 231, a source electrode (not labeled) connected to the corresponding data line 241, and a drain electrode (not labeled) connected to the pixel electrode 27. The first and second common voltage lines 201, 202 are insulated from the scanning lines 231 and the data lines 241; and are arranged at two opposite edge portions of the liquid crystal panel 21, respectively near to and far from the gate driving circuit 23. Moreover, the first and second common voltage lines 201, 202 have no overlap and are parallel to each other. The first and second common voltage lines 201, 202 are also generally parallel to the data lines 241. A plurality of branch lines (not labeled) extend between the first and second common voltage lines 201, 202, each branch line connecting to a respective row of the common electrodes 28. Thereby, the common electrodes 28 are substantially connected to the common voltage source 25 via the first common voltage line 201. Thus, all the common electrodes 28 have the common voltage applied thereto. The common voltage is a constant direct current, and may for example be 5V. The common electrodes 28 are connected to the input terminal 296 also via the first common voltage line 201, and are connected to the output terminal 297 via the second common voltage line 202.

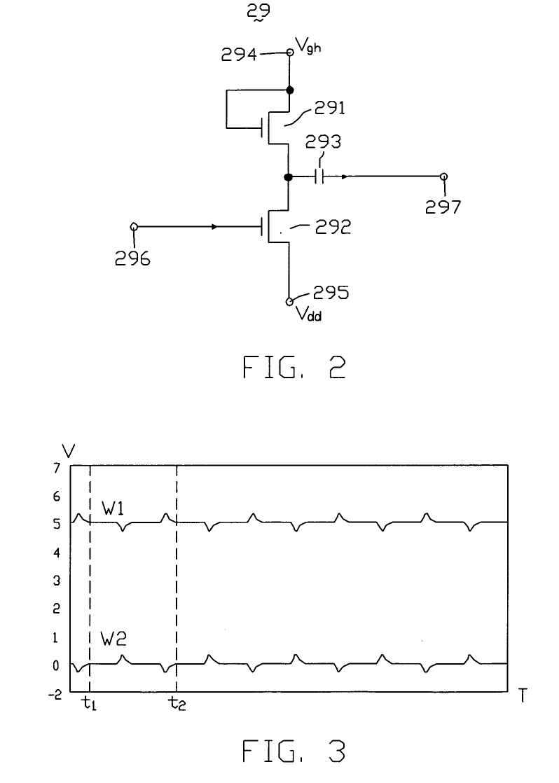

Referring also to FIG. 2, a circuit diagram of the common voltage modulator 29 is shown. The common voltage modulator 29 includes a first transistor 291, a second transistor 292, a capacitor 293, a first direct current end 294, and a second direct current end 295. The first transistor 291 includes a gate electrode (not labeled) connected to the first direct current end 294, a source electrode (not labeled) also connected to the first direct current end 294, and a drain electrode (not labeled) connected to the second direct current end 295 via a drain electrode (not labeled) of the second transistor 292 and a source electrode (not labeled) of the second transistor 292. The second transistor 292 further includes a gate electrode (not labeled) connected to the input terminal 296. The drains of the first and second transistors 291, 292 are connected to the output terminal 297 via the capacitor 293. The first direct current end 294 has a high-level voltage Vgh applied thereto, and the second direct current end 295 has a low-level voltage Vdd applied thereto. The voltage Vgh may for example be 20V, and the voltage Vdd may for example be 1V. The first and second transistors 291, 292 may for example be TFTs.

The timing controller 22 generates a plurality of scanning synchronization signals, and provides the scanning synchronization signals to the gate driving circuit 23. The gate driving circuit 23 thereby applies plural scanning signals to the scanning lines 231 sequentially. When one scanning line 231 is being scanned, the corresponding TFTs 26 that are connected to the scanning line 231 are switched on.

The timing controller 22 further generates a plurality of data synchronization signals, and provides the scanning synchronization signals to the data driving circuit 24. The gate driving circuit 24 thereby applies plural gray scale voltages to the data lines 241 simultaneously each time one of the scanning lines 231 is being scanned. The gray scale voltages are applied to corresponding pixel electrodes 27 via the corresponding on-state TFTs 26.

Generally, the scanning lines 231 and the data lines 241 are insulated from each other by an insulating layer provided therebetween. Therefore, parasitic capacitors are formed between the scanning lines 231 and the data lines 241. When the gray scale voltages applied to the pixel electrodes 27 are pulled up or pulled down rapidly, the common voltages of the common electrodes 18 corresponding to the pixel electrodes 27 are correspondingly pulled up or pulled down due to the coupling effect of the parasitic capacitors. In this situation, the applied common voltage is distorted, and the distorted common voltage becomes an actual common voltage of each affected common electrode 28. The common voltage modulator 29 receives the distorted actual common voltage from the first common voltage line 201, and applies a corresponding compensating voltage to the second common voltage line 202. In the following description, for simplicity, the sum of the distorted actual common voltages will be referred to simply as “the distorted actual common voltage.”

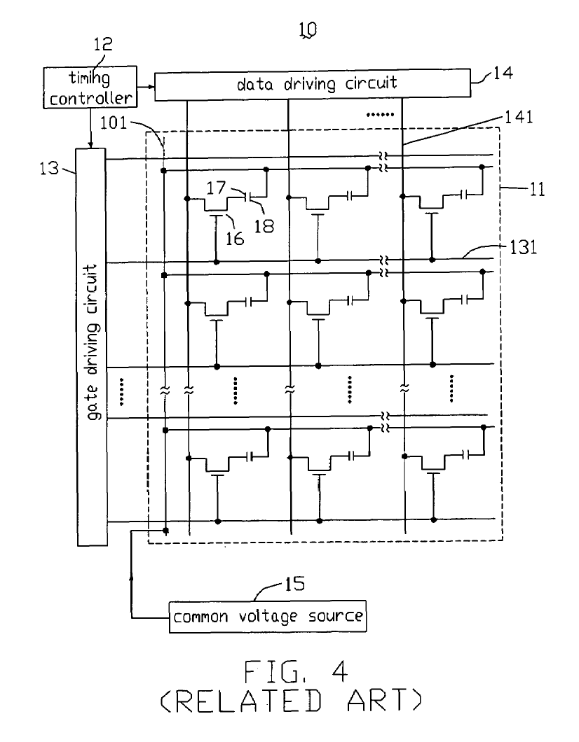

Referring also to FIG. 3, this is a schematic timing chart of waveforms of the distorted actual common voltage and the compensating voltage. In the chart, W1 represents the waveform of the distorted common voltage, and W2 represents the waveform of the compensating voltage. As shown in FIG. 3, W1 has a number of upward and downward ripples occurring alternately, which ripples are due to the coupling effect. W2 has a number of upward ripples corresponding to the downward ripples of W1, and a number of downward ripples corresponding to the upward ripples of W1.

The working principle of the common voltage modulator 29 is described in detail as follows. A time period t1˜t2 is taken as an example.

During the period t1˜t2, when W1 is smooth with no ripples, the first transistor 291 is switched on. This is because the gate electrode of the first transistor 291 is connected to the first direct current end 294, which has a high-level voltage Vgh applied thereto. The second transistor 292 is switched on. This is because the gate electrode of the second transistor 292 is connected to the first common voltage line 201, which has a 5V common voltage applied thereto. At this time, no operation is performed to affect the capacitor 293, and the compensating voltage is 0V.

When W1 has a downward ripple, the common voltage applied to the gate electrode of the second transistor 292 is reduced. Thus, an on-state resistance between the source electrode and the drain electrode of the second transistor 292 is increased. Because the first direct current end 294 and the second direct current input 295 have constant voltages Vgh and Vdd applied thereto respectively, a voltage between the first direct current end 294 and the second direct current end 295 is constant. Thus, a voltage division of the second transistor 292 is increased. The voltage of the drain electrode of the second transistor 292 is increased. A voltage of one end of the capacitor 293 connected to the drain electrode of the second transistor 292 is increased. Thereby, a voltage of the other end of the capacitor 293 connected to the output terminal 297 is pulled up due to the coupling effect, and exceeds 0V. The compensating voltage output by the common voltage modulator 29 is thus greater than 0V, and has an upward ripple corresponding to the downward ripple of W1.

When W1 has an upward ripple, the common voltage applied to the gate electrode of the second transistor 292 is increased. Accordingly, the on-state resistance between the source electrode and the drain electrode of the second transistor 292 is reduced. Thus, the voltage division of the second transistor 292 is reduced. The voltage of the drain electrode of the second transistor 292 is reduced. The voltage of one end of the capacitor 293 connected to the drain electrode of the second transistor 292 is reduced. Thereby, the voltage of the other end of the capacitor 293 connected to the output terminal 297 is pulled down due to the coupling effect, and is below 0V. The compensating voltage output by the common voltage modulator 29 is thus less than 0V, and has a downward ripple corresponding to the upward ripple of W1.

In summary, each time the common voltage has a ripple, the compensating voltage immediately applied by the common voltage modulator 29 has a corresponding ripple but with a reverse orientation. The compensating voltage having the reverse orientation ripple is applied to the common electrodes 28 via the second common voltage line 202. Thus the ripple of the distorted common voltage is cancelled out or compensated, such that the common voltage of the common electrode 28 remains substantially stable. That is, the compensating voltage smoothes the distorted actual common voltage, whereby the actual common voltage can be almost exactly the same as the predetermined common voltage. Accordingly, impairment of images displayed by the LCD 20 is reduced or even eliminated, and the LCD 20 provides good performance.

For example, it has been demonstrated that when the high-level voltage Vgh is within a range from 15V to 25V, and the low-level voltage Vdd is within a range from 0V to 3.3V, the LCD 20 displays images of good quality.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display comprising:
a common electrode capable of having a predetermined common voltage applied thereto;
a first common voltage line connected to the common electrode;
a second common voltage line connected the common electrode, the first and second common voltage lines having no overlap and being at opposite sides of the liquid crystal display; and
a common voltage modulator connected to the first and second common voltage lines;
wherein the common voltage modulator is configured to receive a distorted common voltage from the common electrode via the first common voltage line, and apply a corresponding compensating voltage to the common electrode via the second common voltage line.

2. The liquid crystal display of claim 1, wherein the common voltage modulator comprises an input terminal connected to the first common voltage line and an output terminal connected to the second common voltage line, the input terminal being capable of receiving the distorted common voltage, and the output terminal being capable of providing the compensating voltage to the second common voltage line.

3. The liquid crystal display of claim 1, wherein the common voltage modulator further comprises a first transistor, a second transistor, a first direct current end, a second direct current end, and a capacitor, the first transistor comprising a gate electrode connected to the first direct current end, and a source connected to the first direct current end, the second transistor comprising a gate electrode connected to the input terminal, and a source electrode connected to the second direct current end, drain electrodes of the first and second transistors being connected to the output terminal via the capacitor.

4. The liquid crystal display of claim 1, further comprising a liquid crystal panel, wherein the common electrode and the first and second common voltage lines are disposed in the liquid crystal panel, and the first and second common voltage lines are arranged at two opposite sides of the liquid crystal panel.

5. The liquid crystal display of claim 1, wherein the distorted common voltage and the compensating voltage are representable as waveforms having ripples, and the ripples of the compensating voltage are reversely oriented relative to the ripples of the distorted common voltage.

6. The liquid crystal display of claim 5, wherein the ripples of the distorted common voltage comprise upwardly oriented ripples and downwardly oriented ripples occurring alternately, and the ripples of the compensating voltage comprise downwardly oriented ripples and upwardly oriented ripples occurring alternately.

7. The liquid crystal display of claim 1, wherein the predetermined common voltage is approximately 5 volts.

8. The liquid crystal display of claim 2, wherein the first direct current end is capable of having a high-level voltage applied thereto, the high-level voltage being in the range from 15 volts to 25 volts.

9. The liquid crystal display of claim 2, wherein the second direct current end is capable of having a low-level voltage applied thereto, the low-level voltage being in the range from 0 volts to 3.3 volts.

10. The liquid crystal display of claim 1, further comprising a plurality of scanning lines parallel to each other, a plurality of data lines parallel to each other and orthogonal to the scanning lines, a plurality of thin film transistors arranged in the vicinity of points of intersection of the scanning lines and the data lines, and a plurality of pixel electrodes corresponding to the thin film transistors and located generally opposite to the common electrode.

11. The liquid crystal display of claim 10, wherein the first and second common voltage lines are insulated from the scanning lines and the data lines.

12. The liquid crystal display in claim 10, further comprising a gate driving circuit configured for providing a plurality of scanning signals to the scanning lines, and a data driving circuit configured for providing a plurality of gray scale voltages to the data lines.

13. A liquid crystal display comprising:
a common electrode capable of having a predetermined common voltage applied thereto;
a first common voltage line connected to the common electrode;
a second common voltage line connected to the common electrode; and
a common voltage modulator configured for receiving an actual common voltage from the first common voltage line and providing a corresponding compensating voltage to the second common voltage line;
wherein the actual common voltage is representable by a first waveform, the first waveform comprises a plurality of ripples, the compensating voltage is representable by a second waveform, and the second waveform comprises a plurality of ripples corresponding to but reversely oriented relative to the ripples of the actual common voltage.

14. The liquid crystal display of claim 13, wherein when the actual common voltage has an upward ripple, the compensating voltage outputted by the common voltage modulator has a corresponding downward ripple, and when the actual common voltage has a downward ripple, the compensating voltage outputted by the common voltage modulator has a corresponding upward ripple.

15. The liquid crystal display of claim 13, wherein the common voltage modulator comprises an input terminal connected to the first common voltage line and an output terminal connected to the second common voltage line, the input terminal being capable of receiving the distorted common voltage, the output terminal being capable of providing the compensating voltage to the second common voltage line.

16. The liquid crystal display of claim 15, wherein the common voltage modulator further comprises a first transistor, a second transistor, a first direct current end, a second direct current end, and a capacitor, the first transistor comprising a gate electrode connected to the first direct current end, and a source electrode connected to the first direct current end, the second transistor comprising a gate electrode connected to the input terminal, and a source electrode connected to the second direct current end, drain electrodes of the first and second transistors being connected to the output terminal via the capacitor.

17. The liquid crystal display of claim 16, wherein the first direct current end is capable of having a high-level voltage applied thereto, the high-level voltage being in the range from 15 volts to 25 volts.

18. The liquid crystal display of claim 16, wherein the second direct current end is capable of having a low-level voltage applied thereto, the low-level voltage being in the range from 0 volts to 3.3 volts.

19. The liquid crystal display of claim 13, further comprising a plurality of scanning lines parallel to each other, a plurality of data lines parallel to each other and orthogonal to the scanning lines, a plurality of thin film transistors located in the vicinity of points of intersection of the scanning lines and the data lines, and a plurality of pixel electrodes corresponding to the thin film transistors and located generally opposite to the common electrode, the first and second common voltage lines being insulated from the scanning lines and the data lines.
